(19) United States
(12) Patent Application Publication
(10) Pub. No.: US 2024/0290948 A1
(43) Pub. Date: Aug. 29, 2024

(54) POSITIVE ELECTRODE FOR LITHIUM SULFUR BATTERY, AND LITHIUM SULFUR BATTERY

(71) Applicant: ABRI Co., Ltd., Japan (JP)

(72) Inventors: Jungo Wakasugi, Tokyo (JP); Koshin Takemoto, Tokyo (JP); Masaaki Kubota, Tokyo (JP); Hidetoshi Abe, Tokyo (JP); Kiyoshi Kanamura, Tokyo (JP)

(73) Assignee: ABRI Co., Ltd., Tokyo (JP)

(21) Appl. No.: 18/649,512

(22) Filed: Apr. 29, 2024

Related U.S. Application Data
(63) Continuation of application No. PCT/JP2022/035660, filed on Sep. 26, 2022.

(30) Foreign Application Priority Data
Oct. 29, 2021 (JP) 2021-177584

(51) Int. Cl. H01M 4/36; H01M 4/02; H01M 4/38; H01M 4/485; H01M 4/58; H01M 4/60

(52) U.S. Cl. CPC H01M 4/364; H01M 4/485; H01M 4/5815; H01M 4/602; H01M 2004/027; H01M 2004/028; H01M 4/382; H01M 2300/0028

(57) ABSTRACT

The present disclosure provides a positive electrode which includes a positive electrode current collector and a positive electrode mixture layer, wherein the positive electrode mixture layer contains sulfur and/or a sulfur compound, a ceramic material that is oxidized and reduced in a potential range of 1.0V (vs. Li/Li+) to 3.0V (vs. Li/Li+), a binder, and a proportion of the sulfur and/or the sulfur compound in the positive electrode mixture layer is 40% by mass to 80% by mass.

### CROSS-REFERENCE TO RELATED APPLICATIONS

This application is a Continuation Application of PCT Application No. PCT/JP2022/035660, filed Sep. 26, 2022 and based upon and claiming the benefit of priority from prior Japanese Patent Application No. 2021-177584, filed Oct. 29, 2021, the entire contents of all of which are incorporated herein by reference.

### FIELD

The present disclosure relates to a positive electrode for lithium-sulfur battery and lithium-sulfur battery.

### BACKGROUND

Lithium-ion battery is widely used in small electronic devices, electric vehicles, and equipment such as smart grids. In contrast, battery with even greater energy density is required to promote the spread of electric vehicles and the use of natural energy. Therefore, development of a new lithium-ion battery that can replace the lithium-ion battery using a lithium composite oxide such as LiCoO₂ as a constituent material of the positive electrode has been desired.

Sulfur has an extremely high theoretical capacity density of 1,672 mAhg⁻¹, and lithium-sulfur battery using sulfur as a constituent material of the positive electrode has the potential to theoretically achieve a high energy density among post-lithium-ion battery. Therefore, research and development of lithium-sulfur battery has been actively carried out.

A lithium-sulfur battery is comprised of a positive electrode containing sulfur and a negative electrode containing lithium metal, which are accommodated in an outer casing in a state of facing each other via a separator. The separator is impregnated with an electrolyte in which a lithium salt is dissolved.

Lithium-sulfur battery has a problem that, during charging and discharging, sulfur molecules and intermediate products (lithium polysulfide, etc.) dissolve and diffuse into the electrolyte, self-discharge and deterioration in negative electrode are caused and the battery performance is degraded.

Therefore, in order to solve such a problem, a combination of carbon materials and sulfur, modification of the electrolyte, improvement of separators, and the like have been proposed. For example, JP 2005-251469 A proposes a lithium-sulfur battery in which ZnO and Al₂O₃, or ZnO and Sb₂O₅ are added to the positive electrode to suppress the dissolving of sulfur from the positive electrode.

### SUMMARY

In the positive electrode of the lithium-sulfur battery, an intermediate product which is soluble in the electrolyte is generated during the charging and discharging process. For this reason, the viscosity of the electrolyte is increased and the lithium ion conductivity is reduced due to the dissolution of the intermediate product. In addition, there is a problem that the intermediate product diffuses in the electrolyte and reaches the negative electrode, causing a redox shuttle effect and increasing the irreversible capacity. Although JP 2005-251469 A takes this countermeasure, it is still inadequate.

The object of the present disclosure is to improve the lithium ion conductivity and the electronic conductivity in the electrode and provide a positive electrode and a lithium-sulfur battery with a good capacity retention which is not significantly degraded in the initial capacity, capable of suppressing the dissolution of the intermediate products in an electrolyte by adsorbing the intermediate products into the additive, by a simple method of adding ceramic powder to the electrode.

A positive electrode mixture layer in which sulfur and/or a sulfur compound, a conductive additive, a binder, and a thickener are combined is often used for the positive electrode of the lithium-sulfur battery. The present inventors conducted various studies and verifications of the structure, composition and the like of the positive electrode. As a result, the inventors found that battery characteristics are greatly improved by using ceramic powder that is oxidized and reduced at 1.0V (vs. Li/Li⁺) to 3.0V (vs. Li/Li⁺) in the positive electrode mixture layer.

In order to solve the above problems, the positive electrode of the present disclosure is a positive electrode including a positive electrode current collector and a positive electrode mixture layer, wherein the positive electrode mixture layer contains sulfur and/or a sulfur compound, a ceramic material oxidized and reduced in a potential range of 1.0V (vs. Li/Li⁺) to 3.0V (vs. Li/Li⁺), and a binder and the proportion of the sulfur and/or the sulfur compound in the positive electrode mixture layer is 40% by mass to 80% by mass.

The content of the ceramic material in the positive electrode mixture layer may be 1% by mass or more and 20% by mass or less.

The ceramic material may be a ceramic that adsorbs a lithium polysulfide, and the lithium polysulfide is generated during charging and discharging of the lithium-sulfur battery.

The sulfur compound may be at least one or more of compounds selected from Li₂Sₙ (n≥1), an organic sulfur compound and a carbon-sulfur polymer ((C₂Sₓ)ₙ, where, x=2.5 to 50, n≥2).

The ceramic material may be at least one or more selected from

$${Li}_{4} {Ti}_{5} {O}_{12} , {La}_{0.57} {Li}_{0.29} {TiO}_{3} , \\ and {Li}_{1 + x + y} {Al}_{x} {Ti}_{2 - x} {Si}_{y} {P}_{3 - y} {O}_{12} ( 0 \leq x \leq 1 , 0 \leq y \leq 1 ) .$$

The positive electrode mixture layer further may contain sulfur-modified polyacrylonitrile.

In addition, in order to solve the above problems, the lithium-sulfur battery of the present disclosure includes the positive electrode of the present disclosure, a negative electrode including an active material containing lithium, an electrolyte, and a separator.

In the lithium-sulfur battery of the present disclosure, the lower limit of the discharge potential range may be 1.0 (vs. Li/Li⁺) to 1.5V (vs. Li/Li⁺).

A solubility of a lithium polysulfide in the electrolyte is a range of 0.0 mol/L or more and 1.0 mol/L or less, and the lithium polysulfide is generated in the electrolyte during charging and discharging of the lithium-sulfer battery.

The electrolyte may contain lithium bis(trifluoromethanesulfonyl)imide and sulfolane are mixed at a molar ratio of 1:1 to 1:8.

According to the positive electrode and the lithium-sulfur battery of the present disclosure, the diffusion of lithium polysulfide caused by adsorption on the surface of the ceramic powder can be suppressed by the ceramic material contained in the electrode, and the initial capacity and the capacity retention rate can be improved by promoting the reduction reaction of sulfur and improving the ion conductivity of the electrolyte in the electrode.

In addition, when a material that is oxidized and reduced in a potential region close to sulfur, among the ceramic materials, is added, the additive itself develops capacity while promoting the reaction of sulfur or sulfur compounds, and the battery capacity therefore increases as compared to addition of the other oxide materials.

Moreover, since a simple process of adding ceramic powder when preparing the slurry for the positive electrode mixture layer can be adopted as a method of adding ceramic materials, electrodes can be manufactured stably.

Additional objects and advantages of the disclosure will be set forth in the description which follows, and in part will be obvious from the description, or may be learned by practice of the disclosure. The objects and advantages of the disclosure may be realized and obtained by means of the instrumentalities and combinations particularly pointed out hereinafter.

### DRAWINGS

The accompanying drawings, which are incorporated in and constitute a part of the specification, illustrate embodiments of the disclosure, and together with the general description given above and the detailed description of the embodiments given below, serve to explain the principles of the disclosure.

FIG. 1 is a graph showing a capacity retention rates of Example 1, Comparative Example 1, and Comparative Example 4 in one embodiment.

### DETAILED DESCRIPTION

An embodiment of a positive electrode and a lithium-sulfur battery of the present disclosure will be described below.

### [Positive Electrode]

The positive electrode of the present disclosure is a positive electrode including a positive electrode current collector and a positive electrode mixture layer.

### <Positive Electrode Mixture Layer>

The positive electrode mixture layer contains sulfur and/or a sulfur compound to be described below, a ceramic material, and a binder. The layer may contain a conductive carbon.

(Sulfur and/or Sulfur Compound)

For example, element sulfur can be cited as sulfur, and at least one or more selected from Li₂Sₙ (n≥1), organic sulfur compounds and carbon-sulfur polymers ((C₂Sₓ)ₙ, x=2.5 to 50, n≥2) can be cited as sulfur compounds. Sulfur and/or sulfur compounds may include sulfur or sulfur compounds, or both sulfur and sulfur compounds. In addition, the sulfur compound may contain only one type of compounds as a sulfur compound, and may contain two or more types of compounds. Incidentally, sulfur powder is used in the present specification, but its shape is not limited. In addition, some or all of the sulfur and/or sulfur compounds may be composited with a conductive material containing a carbon material, or may be used without being composited. A composite of sulfur and/or sulfur compounds and a conductive material is hereinafter referred to as sulfur-carbon composite powder.

### [Sulfur-Carbon Composite Powder]

Examples of methods of compositing sulfur and/or sulfur compounds with a conductive material such as carbon include compositing by heat treatment, compositing by mechanochemical treatment, and compositing by electrolytic deposition.

Only one type or two or more types of the method of producing the sulfur-carbon composite powder may be employed and, when two or more types of the methods are employed, the combination and order thereof can be arbitrarily selected according to the purpose.

As the conductive material such as carbon, carbon black, acetylene black, ketjen black, carbon nanotubes (CNT), graphene, artificial graphite, natural graphite, activated carbon, and the like, can be cited, and only one type or two or more types of these materials may be contained.

In addition, sulfur and/or sulfur compounds and the sulfur-carbon composite may be used in combination.

The total amount of sulfur and/or sulfur compounds in the sulfur-carbon composite powder is not particularly limited, but is desirably 60 to 100% by mass, more desirably 70 to 85% by mass. As the rate of the total content is closer to the lower limit, the internal resistance is lower and the charge/discharge characteristics of the battery are improved. As the rate of the total content is closer to the upper limit, the battery capacity per mass of sulfur and/or sulfur compounds is greatly improved. When the rate is less than the lower limit, the battery capacity per mass of sulfur and/or sulfur compounds may decrease, and the energy density of the battery may decrease.

### (Conductive Additive)

The conductive additive is used to improve the electronic conductivity and contains carbon. As the conductive additive, a known or commercially available conductive additive can be used and, for example, carbon black such as acetylene black (hereinafter sometimes referred to as “AB”) or ketjen black, carbon nanotube (CNT), graphene, carbon materials such as carbon fiber, activated carbon, artificial graphite, and natural graphite are included in the examples. Only one type of these carbon materials may be used, or two or more types thereof may be used. In addition, the conductive additive may be the same as the conductive material such as carbon in the sulfur-carbon composite powder.

### (Ceramic Material)

As the ceramic material, ceramic powder that is oxidized and reduced in a potential range of 1.0V (vs. Li/Li⁺) to 3.0V (vs. Li/Li⁺) is used. The ceramic material also acts as a positive electrode active material. Lithium polysulfide dissolves or diffuses from the positive electrode of the lithium-sulfur battery into the electrolyte and reacts with the negative electrode of lithium metal, degrading the battery capacity and the coulombic efficiency. In the present disclosure, such ceramic powder is ceramic that adsorbs lithium polysulfide. Therefore, the degradation in battery capacity and the degradation in coulombic efficiency can be suppressed by using such ceramic powder. In addition, when lithium polysulfide diffuses in the electrolyte and reaches the negative electrode, the redox shuttle effect may occur, which may increase the irreversible capacity. Since the ceramic power adsorbs lithium polysulfide, the amount of diffusion of lithium polysulfide in the electrolyte can be reduced, and the redox shuttle effect can be thereby suppressed. In addition, lithium polysulfides are also more likely to dissolve at a high temperature. Since lithium polysulfide that melts at a high temperature can be adsorbed by adding ceramic powder, a high temperature resistance also increases.

The ceramic material is desirably a titanium-containing oxide. This is because the adsorption effect of lithium polysulfide is enhanced by containing titanium. For example, at least one or more of the materials selected from Li₄Ti₅O₁₂ (hereinafter sometimes referred to as “LTO”), La_{0.57}Li_{0.29}TiO₃, and Li_{1+x+y}AlₓTi₂₋ₓSi_{y}P_{3-y}O₁₂ (0≤x≤1, 0≤y≤1), TiO₂, and TiNb₂O₇ can be cited as the ceramic material. More desirably, the ceramic material is a lithium-titanium composite oxide. This is because oxidation and reduction occur in a potential range of 1.0V (vs. Li/Li⁺) to 3.0V (vs. Li/Li⁺) and lithium ions can be given and received between sulfur and ceramics. For example, at least one or more of the materials selected from Li₄Ti₅O₁₂, La_{0.57}Li_{0.29}TiO₃, and Li₁+x+yAlₓTi₂₋ₓSi_{y}P_{3-y}O₁₂ (0≤x≤1, 0≤y≤1) can be cited as the lithium-titanium composite oxide. Only one type of the materials may be used or two or more types of the materials may be used.

### (Binder)

The binder is not particularly limited, and any known or commercially available binder can be used. For example, polyvinylidene fluoride (PVDF), polytetrafluoroethylene (PTFE), polyvinylpyrrolidone (PVP), polyvinyl chloride (PVC), polyethylene (PE), polypropylene (PP), ethylene-propylene copolymer, styrene-butadiene rubber (SBR), carboxymethyl cellulose (CMC), acrylic resin, and the like can be cited as the binder. Only one type of these binders may be used or two or more types of binders may be used.

### (Other Additives)

In addition, it is desirable to add 1 to 10% by mass of sulfur-modified polyacrylonitrile to the positive electrode mixture layer of the present disclosure. Sulfur-modified polyacrylonitrile has the property of adsorbing lithium polysulfide and can suppress the redox shuttle effect, similarly to ceramic powder.

### (Mass Ratio of Each Component)

In the positive electrode of the present disclosure, the rate of sulfur and/or sulfur compounds in the positive electrode mixture layer is desirably 40% by mass to 80% by mass. If the rate is lower than 40% by mass, the rate of sulfur and/or sulfur compounds is relatively low, and the capacity cannot be secured. If the rate exceeds 80% by mass, the rate of the carbon material and conductive additive in the sulfur-carbon composite powder is relatively decreased, and the electronic conductivity is decreased, thereby decreasing the utilization rate of sulfur and/or sulfur compounds.

In addition, the rate of the sulfur-carbon composite powder in the positive electrode mixture layer is desirably 70% by mass to 95% by mass. When the mass ratio of the sulfur-carbon composite powder is within this range, the performance of a positive electrode can be sufficiently exerted.

In the positive electrode mixture layer, the rate of the total content of the sulfur-carbon composite powder to the total content of the sulfur-carbon composite powder, the conductive additive, the binder, and the ceramic material (([total content of the sulfur-carbon composite powder in the positive electrode mixture layer (parts by mass)]/[total content of sulfur-carbon composite powder, conductive additive, binder, and ceramic material in the positive electrode mixture layer (parts by mass)])×100) is not particularly limited, but is desirably 65 to 95% by mass, and more desirably 75 to 85% by mass. When the rate of the total content is equal to or higher than the lower limit, the internal resistance of the battery can be suppressed. If the rate is lower than the lower limit, the effect of suppressing the internal resistance of the battery may not be obtained. When the rate of the total content is equal to or less than the upper limit, the capacity of the battery is improved. If the rate is higher than the upper limit, the capacity of the battery may become low.

In the positive electrode mixture layer, the rate of the total content of the conductive additive to the total content of sulfur-carbon composite powder, the conductive additive, the binder, and the ceramic material (([content of the conductive additive in the positive electrode mixture layer (parts by mass)]/[total content of sulfur-carbon composite powder, conductive additive, binder, and ceramic material in the positive electrode mixture layer (parts by mass)])×100) is not particularly limited, but is desirably 0 to 20% by mass, and more desirably 5 to 10% by mass. When the rate of the total content is equal to or higher than the lower limit, the charge/discharge capacity of the battery is further improved. If the rate is lower than the lower limit, the effect of improving the charge/discharge capacity of the battery may not be obtained. When the rate of the total content is equal to or less than the upper limit, the effect of using components other than sulfur and the conductive additive can be obtained more remarkably. If the rate is higher than the upper limit, the amount of sulfur may be relatively reduced, and the capacity may be deteriorated.

In the positive electrode mixture layer, the rate of the content of the binder to the total content of the sulfur-carbon composite powder, the conductive additive, the binder, and the ceramic material (([content of the binder in the positive electrode mixture layer (parts by mass)]/[total content of sulfur-carbon composite powder, conductive additive, binder, and ceramic material in the positive electrode mixture layer (parts by mass)])×100) is not particularly limited, but is desirably 3 to 15% by mass, and more desirably 5 to 10% by mass. When the content rate is equal to or higher than the lower limit, the structure of the positive electrode mixture layer can be maintained more stably. If the rate is lower than the lower limit, inconvenience such as peeling or falling off of the positive electrode mixture layer may easily occur. When the content rate is equal to or less than the upper limit, the charge/discharge characteristics of the battery are further improved. If the rate is higher than the upper limit, the charge/discharge characteristics of the battery may be deteriorated.

In the positive electrode mixture layer, the rate of the content of the ceramic material to the total content of the sulfur-carbon composite powder, the conductive additive, the binder, and the ceramic material (([content of ceramic in the positive electrode mixture layer (parts by mass)]/[total content of sulfur-carbon composite powder, conductive additive, binder, and ceramic material in the positive electrode mixture layer (parts by mass)])×100) is not particularly limited, but is desirably 3 to 15% by mass, and more desirably 5 to 10% by mass. The actual capacity of the lithium-sulfur battery increases when the content rate is equal to or more than the lower limit, and the effect of adding the ceramic material is remarkably recognized and the battery characteristics are improved when the content rate is equal to or less than the upper limit.

### (Thickness of Positive Electrode Mixture Layer)

The thickness of the positive electrode mixture layer may be a general thickness and, for example, the value of the electrode taken out from a battery of SOC at 0% that has completed initial activation, in a state in which the battery can be distributed as a product is 20 μm to 100 μm.

### <Positive Electrode Current Collector>

The positive electrode current collector is not particularly limited, and a known or commercially available current collector can be used, such as aluminum or an aluminum alloy. Examples of materials for the positive electrode current collector include, for example, aluminum foil, carbon-coated aluminum foil, meshes of metals such as aluminum, porous metals, expanded metals, and punched metals.

The positive electrode mixture layer can be formed by, for example, dispersing the material in a solvent to form a slurry, applying the slurry to the positive electrode current collector, and then drying and removing the solvent. The positive electrode mixture layer may be formed only on one side of the positive electrode current collector or may be formed on both sides.

### [Lithium-Sulfur Battery]

The lithium-sulfur battery of the present disclosure includes the positive electrode of the present disclosure, a negative electrode to be described below, an electrolyte, and a separator. The battery is formed by impregnating the positive electrode, the negative electrode, and the separator with the electrolyte.

As the negative electrode, a negative electrode containing an active material that absorbs and releases lithium is used. For example, the negative electrode active material is selected from metal materials such as metallic lithium, lithium aluminum alloy, lithium tin alloy, lithium lead alloy, and lithium silicon alloy and, carbon materials such as natural graphite, artificial graphite, carbon black, acetylene black, graphite, activated carbon, carbon fiber, coke, soft carbon, and hard carbon, and oxide materials such as lithium titanate, and the like. One or more of the negative electrode active materials can be used. When two or more of the negative electrode active materials are used, their combination and ratio can be arbitrarily selected according to the purpose.

### <Negative Electrode>

In addition, the negative electrode may further contain a conductive material to allow electrons to transfer smoothly within the negative electrode, together with the negative electrode active materials.

For example, carbon-based materials such as carbon black, acetylene black, ketjen black, carbon nanotubes (CNT), graphene, and reduced graphene oxide, or conductive polymers such as polyaniline, polythiophene, polyacetylene, and polypyrrole can be used as the conductive material. The conductive material is desirably contained in an amount of 0 to 20% by mass with respect to the total mass of the negative electrode active material layer. If the content of the conductive material exceeds 20% by mass, the content of the negative electrode active material may become relatively small and the capacity characteristics of the battery may be deteriorated.

In addition, the negative electrode may further contain a binder which can play a role for a pasting of the negative electrode active material, improvement of adhesion between the active materials or between the active material and the negative electrode current collector, and an effect of a buffer against expansion and contraction of the active material. More specifically, the material which is the same as the binder used for the positive electrode mixture layer can be used as the binder.

In addition, the negative electrode may further include a negative electrode current collector for supporting the negative electrode mixture layer containing the negative electrode active material, the conductive material, and the binder. When the negative electrode includes a negative electrode current collector, the negative electrode mixture layer may be formed only on one side of the negative electrode current collector or may be formed on both sides.

More specifically, the negative electrode current collector can be selected from a group consisting of copper, aluminum, stainless steel, titanium, silver, palladium, nickel, alloys thereof, and combinations thereof. Stainless steel may be surface treated with carbon, nickel, titanium or silver, and examples of the alloys include aluminum-cadmium alloy and the like. Moreover, baked carbon, non-conductive polymer surface-treated with a conductive material, conductive polymer, or the like can be used as the negative electrode current collector. In addition, a lithium metal thin film may be used as the negative electrode.

### <Electrolyte>

A known or commercially available electrolyte can be used as the electrolyte. For example, an electrolyte in which a solubility of lithium polysulfide is 0.0 mol/L or more and 1.0 mol/L or less as the electrolyte. In other words, an electrolyte in which the lithium polysulfide is insoluble, or if the lithium polysulfide is dissolved, lithium polysulfide is dissolved in 1.0 mol/L or less can be used as the electrolyte.

In the positive electrode of the lithium-sulfur battery, lithium polysulfide is produced as an intermediate product that is soluble in the electrolyte during the charging and discharging process. When the intermediate product dissolves in the electrolyte, the viscosity of the electrolyte increases and the lithium ion conductivity decreases. By using an insoluble electrolyte in which the solubility of lithium polysulfide is 1.0 mol/L or less, the decrease in lithium ion conductivity can be suppressed.

As the electrolyte in which the solubility of lithium polysulfide is 0.0 mol/L or more and 1.0 mol/L or less, for example, an electrolyte in which lithium bis(trifluoromethanesulfonyl)imide and sulfolane are mixed at a molar ratio of 1:1 to 1:8 can be used.

In addition, a non-aqueous organic solvent containing lithium salt may also be used as the electrolyte. For example, polar solvents and ionic liquids such as aryl compounds, bicyclic ethers, acyclic carbonates, sulfoxide compounds, lactone compounds, ketone compounds, ester compounds, sulfate compounds, and sulfite compounds can be used as the non-aqueous organic solvent.

More specifically, 1,2-dimethoxyethane, 1,2-diethoxyethane, 1,2-dibutoxyethane, dioxolane (DOL), 1,4-dioxane, tetrahydrofuran, 2-methyl tetrahydrofuran, dimethyl carbonate (DMC), diethyl carbonate (DEC), ethyl methyl carbonate (EMC), methyl propyl carbonate (MPC), ethyl propyl carbonate, dipropyl carbonate, butyl ethyl carbonate, ethyl propanoic acid (EP), toluene, xylene, dimethyl ether (DME), diethyl ether, triethylene glycol monomethyl ether (TEFME), diglyme, tetraglyme, hexamethylphosphoric acid triamide, γ-butyrolactone (GBL), acetonitrile, propionitrile, ethylene carbonate (EC), propylene carbonate (PC), N-methylpyrrolidone, 3-methyl-2-oxazolidone, acetate, butyrate and propionate, dimethylformamide, sulfolane (SL), methylsulfolane, dimethylacetamide, dimethylsulfoxide, dimethyl sulfate, ethylene glycol diacetate, dimethyl sulfite, ethylene glycol sulfite, or the like, can be cited as the non-aqueous organic solvent. One or more of these non-aqueous organic solvents can be used.

A cation moiety constituting the ionic liquid may be either an organic cation or an inorganic cation, but is desirably an organic cation.

An anion moiety constituting the ionic liquid may be either an organic anion or an inorganic anion.

As the organic cation among the cation moieties, for example, imidazolium cation, pyridinium cation, pyrrolidinium cation, phosphonium cation, ammonium cation, sulfonium cation, and the like, can be cited and one or more of the cations can be used.

However, the organic cation is not limited to these.

As the organic anion among the anion moieties, alkylsulfate anion such as methylsulfate anion (CH₃SO₄⁻) or ethylsulfate anion (C₂H₅SO₄⁻); tosylate anion (CH₃C₆H₄SO₃⁻); alkanesulfonate anion such as methanesulfonate anion (CH₃SO₃⁻), ethanesulfonate anion (C₂H₅SO₃⁻), or butanesulfonate anion (C₄H₉SO₃⁻); perfluoroalkanesulfonate anion such as trifluoromethanesulfonate anion (CF₃SO₃⁻), pentafluoroethanesulfonate anion (C₂F₅SO₃⁻), heptafluoropropanesulfonate anion (C₃F₇SO₃⁻), or nona fluorobutanesulfonate anion (C₄F₉SO₃⁻); perfluoroalkanesulfonylimide anions such as bis(trifluoromethanesulfonyl)imide anion ((CF₃SO₂)N⁻), bis(nonafluorobutanesulfonyl)imide anion ((C₄F₉SO₂)N⁻), nonafluoro-N-[(trifluoromethane)sulfonyl]butanesulfonylimide anion ((CF₃SO₂)(C₄F₉SO₂)N⁻), or N,N-hexafluoro-1,3-disulfonylimide anion (SO₂CF₂CF₂CF₂SO₂N⁻); acetate anion (CH₃COO⁻); hydrogen sulfate anion (HSO₄⁻); and the like, can be cited, and one or more of these can be used.

However, the organic anion is not limited to these.

As the inorganic anion among the anion moieties, for example, bis(fluorosulfonyl)imide anion (N(SO₂F)₂⁻); hexafluorophosphate anion (PF₆⁻); tetrafluoroborate anion (BF₄⁻); halide anion such as chloride ion (Cl⁻), bromide ion (Br⁻), or iodide ion (I⁻); tetrachloroaluminate anion (AlCl₄⁻), thiocyanate anion (SCN⁻), and the like, can be cited, and one type or two or more types of these can be used.

However, the inorganic anion is not limited to these.

For example, an ionic liquid comprised of a combination of any of the above cation moieties and any of the above anion moieties can be cited as the ionic liquid.

As the ionic liquid in which the cation moiety is an imidazolium cation, for example, 1-ethyl-3-methylimidazolium bis(trifluoromethanesulfonyl)imide, 1-butyl-3-methylimidazolium bis(trifluoromethanesulfonyl)imide, 1-methyl-3-propylimidazolium bis(trifluoromethanesulfonyl)imide, 1-hexyl-3-methylimidazolium bis(trifluoromethanesulfonyl)imide, 1-ethyl-3-methylimidazolium chloride, 1-butyl-3-methylimidazolium chloride, 1-ethyl-3-methylimidazolium methanesulfonate, 1-butyl-3-methylimidazolium methanesulfonate, 1,2,3-trimethylimidazolium methylsulfate, methylimidazolium chloride, methylimidazolium hydrogen sulfate, 1-ethyl-3-methylimidazolium hydrogen sulfate, 1-butyl-3-methylimidazolium hydrogen sulfate, 1-butyl-3-methylimidazolium hydrogen sulfate, 1-ethyl-3-methylimidazolium tetrachloroaluminate, 1-butyl-3-methylimidazolium tetrachloroaluminate, 1-ethyl-3-methylimidazolium acetate, 1-butyl-3-methylimidazolium acetate, 1-ethyl-3-methylimidazolium ethyl sulfate, 1-butyl-3-methylimidazolium methyl sulfate, 1-ethyl-3-methylimidazolium thiocyanate, 1-butyl-3-methylimidazolium thiocyanate, 1-ethyl-2,3-dimethylimidazolium ethyl sulfate, and the like can be cited, and one or two or more types of these can be used.

As the ionic liquid in which the cation moiety is a pyridinium cation, for example, 1-butylpyridinium bis(trifluoromethanesulfonyl)imide, 1-butyl-3-methylpyridinium bis(trifluoromethanesulfonyl)imide, and the like, can be cited, and one type or two or more types of these can be used.

As the ionic liquid in which the cation moiety is a pyrrolidinium cation, for example, 1-methyl-1-propylpyrrolidinium bis(trifluoromethanesulfonyl)imide, 1-butyl-1-methylpyrrolidinium bis(trifluoromethanesulfonyl) imide, and the like, can be cited, and one type or two or more types of these can be used.

As the ionic liquid in which the cation moiety is a phosphonium cation, for example, tetrabutylphosphonium bis(trifluoromethanesulfonyl)imide, tributyldodecylphosphonium bis(trifluoromethanesulfonyl)imide, and the like, can be cited, and one type or two or more types of these can be used.

As the ionic liquid in which the cation moiety is an ammonium cation, for example, methyltributylammonium methylsulfate, butyltrimethylammonium bis(trifluoromethanesulfonyl)imide, trimethylhexylammonium bis(trifluoromethanesulfonyl)imide, and the like, can be cited, and one type or two or more types of these can be used.

In addition, the lithium salt can be used without any particular limitation as long as the lithium salt is a compound which can provide lithium ions used in a lithium ion battery. For example, LiPF₆, LiClO₄, LiAsF₆, LiBF₄, LiSbF₆, LiAlO₄, LiAlCl₄, LiCF₃SO₃, LiC₄F₉SO₃, LIN(C₂F₅SO₃)₂, LiN(C₂F₅SO₂)₂ (Lithium bis(perfluoroethylsulfonyl) imide, BETI), LIN(CF₃SO₂)₂ (Lithium bis(Trifluoromethylesulfonyl) imide, LiTFSI), LiN(CₐF₂ₐ₊₁SO₂)(C_{b}F_{2b+1}SO₂) (where a and b are natural numbers, desirably 1≤a≤20 and 1≤b≤20), lithium poly[4,4′-(hexafluoroisopropylidene)diphenoxy]sulfonyl imide (LiPHFIPSI), LiCl, LiI, LIB(C₂O₄)₂ and the like can be cited, and one type or two or more types of these can be used.

In addition, the electrolyte may be diluted with an organic solvent such as hydrofluoroether, and the concentration and viscosity can be adjusted according to the purpose.

### <Separator>

The separator is a physical separation membrane having a function of physically separating the electrodes, and any ordinary separator used as a separator in a lithium-sulfur battery can be used without particular limitation. For example, a separator having a low resistance to ion transfer of the electrolyte and an excellent electrolyte moisture-containing capacity can be used. More specifically, porous polymer films, for example, porous polymeric films produced with polyolefin polymers such as ethylene homopolymer, propylene homopolymer, ethylene/butene copolymer, ethylene/hexene copolymer and ethylene/methacrylate copolymer can be used alone or together under stacked films. In addition, ordinary porous nonwoven fabrics, for example, nonwoven fabrics formed of high melting point glass fiber, polyethylene terephthalate fiber, or the like, can be used, but are not limited to these. Furthermore, the separator may be formed of one or more layers of these materials, and may be in the form of a sheet or other shape such as a zigzag fold.

### (Lower Limit of Discharge Potential Range)

In the lithium-sulfur battery of the present disclosure, the lower limit of the discharge potential range is desirably 1.0 (vs. Li/Li⁺) to 1.5V (vs. Li/Li⁺). More desirably, the lower limit is 1.0 (vs. Li/Li⁺) to 1.2V (vs. Li/Li⁺). By setting the lower limit of the discharge potential range to 1.0 (vs. Li/Li⁺) to 1.5V (vs. Li/Li⁺), the ceramic material in the positive electrode can be sufficiently reduced, a reaction proceeds between the ceramic material and sulfur and/or sulfur compounds in the positive electrode, and the capacity of the battery can be increased as a result. As a result of the inventors' intensive study, it became clear that when sulfur powder unreacted at approximately 2.0V (vs. Li/Li⁺), among the sulfur powder, reacted between the added ceramic material and the active material and the utilization rate of sulfur was improved when the lower limit of the discharge potential range was set to the above-described value. As a result, the difference between the theoretical capacity and the capacity, which has been a problem, can be reduced, and the capacity of the battery can be increased.

### EXAMPLES

The present disclosure will be described below in detail using examples.

### (Example 1) [Preparation of Positive Electrode for Lithium-Sulfur Battery]

Commercially available ketjen black powder (EC300J, manufactured by Lion Specialty Chemicals Co., Ltd., primary particle size: 39.5 nm) and sulfur powder (sulfur crystal, manufactured by Kanto Chemical Co., Ltd.) were kneaded in a mortar and subjected to heat treatment at 155° C. for 12 hours in a tube furnace in an argon atmosphere, and sulfur-carbon composite powder was thereby obtained. The mixing ratio of ketjen black powder and sulfur powder was 30:70 in terms of mass ratio.

As the ceramic material added to the positive electrode mixture layer, Li₄Ti₅O₁₂ was used as ceramic powder oxidized and reduced in the potential range of 1.0V (vs. Li/Li⁺) to 3.0V (vs. Li/Li⁺).

Next, a positive electrode mixture layer slurry was prepared by mixing the sulfur-carbon composite powder, acetylene black which is a conductive additive, a ceramic material which is an additive, carboxymethyl cellulose and styrene-butadiene rubber which are binders, in distilled water. The mass ratio of the sulfur-carbon composite powder, the ceramic material, AB that is the conductive additive, and the binder (hereinafter “sulfur-carbon composite powder:ceramics:AB:binder”) was 80:5:10:5.

### [Preparation of Lithium Sulfur Battery]

The positive electrode obtained in the above manner was punched out at φ14 and used as a positive electrode for evaluation. A polyimide porous membrane punched out at φ17 was used as the separator, and the lithium metal negative electrode was prepared by punching out a lithium metal foil with a thickness of 600 μm at @15. A mixture of lithium bis(trifluoromethanesulfonyl)imide (LiTFSI) and sulfolane at a molar ratio of 1:2 was used as the electrolyte.

A lithium-sulfur battery was prepared using a beaker-type cell. More specifically, the positive electrode, separator, and lithium metal negative electrode obtained in the above manner were arranged in an argon atmosphere at ambient pressure such that the positive electrode mixture layer faced the negative electrode via the separator, and each member was soaked with the electrolyte.

In addition, a lithium-sulfur battery was prepared using a coin-type cell container. More specifically, the positive electrode, separator, and lithium metal negative electrode obtained in the above manner were arranged such that the positive electrode mixture layer faced the negative electrode via the separator. Each member was soaked with the electrolyte. A spacer and a leaf spring were arranged on the back surface of the negative electrode. Each member was placed in a casing with a gasket, and the casing was covered with a cap, sealed by caulking and sealed. The preparation of the lithium sulfur battery was performed in an argon atmosphere at ambient pressure.

The beaker-type cell and coin-type cell lithium-sulfur batteries of Example 1 in which the lithium metal negative electrode, the separator, and the positive electrode were stacked in this order, were obtained by the above process.

### Example 2

A lithium-sulfur battery of Example 2 was obtained in the same process as that in Example 1, except for using Li_{0.35}La_{0.55}TiO₃ (hereinafter also referred to as LLTO) as a ceramic material oxidized and reduced in a potential range of 1.0V (vs. Li/Li⁺) to 3.0V (vs. Li/Li⁺), as the ceramic material to be added to the positive electrode mixture layer.

### Example 3

A lithium-sulfur battery of Example 3 was obtained in the same process as that in Example 1, except for using LiCGC (registered trademark) (manufactured by Ohara Co., Ltd.) that is Li_{1+x+y}AlₓTi₂₋ₓSi_{y}P_{3-y}O₁₂ (0≤x≤1, 0≤y≤1) as a ceramic material oxidized and reduced in a potential range of 1.0V (vs. Li/Li⁺) to 3.0V (vs. Li/Li⁺), as the ceramic material to be added to the positive electrode mixture layer.

### Example 4

A lithium-sulfur battery of Example 4 was obtained in the same process as that in Example 1, except for setting the ratio of sulfur-carbon composite powder:ceramics:AB:binder to 90:5:2:3.

### Example 5

A lithium sulfur battery of Example 5 was obtained in the same process as that in Example 1, except for setting the ratio of sulfur-carbon composite powder:ceramics:AB:binder to 84:1:10:5.

### Example 6

A lithium sulfur battery of Example 6 was obtained in the same process as that in Example 1, except for setting the ratio of sulfur-carbon composite powder:ceramics:AB:binder to 83:2:10:5.

### Example 7

A lithium sulfur battery of Example 7 was obtained in the same process as that in Example 1, except for setting the ratio of sulfur-carbon composite powder:ceramics:AB:binder to 75:10:10:5.

### Example 8

A lithium sulfur battery of Example 8 was obtained in the same process as that in Example 1, except for setting the ratio of sulfur-carbon composite powder:ceramics:AB:binder to 65:20:10:5.

### Example 9

A lithium-sulfur battery of Example 9 was obtained in the same process as that in Example 1, except for using an electrolyte (1M LiTFSI DOL/DME (1.5% by mass LiNO₃)) obtained by dissolving lithium nitrate (LiNO₃) of 1.5% by mass, in an electrolyte obtained by dissolving LiTFSI in a mixed solvent of dioxolane (DOL) and dimethoxyethane (DME) at a volume ratio of 1:1 such that a concentration was 1 mol/L, as an electrolyte with high solubility of lithium polysulfide. However, only the coin-type cell was prepared, and the beaker-type cell was not prepared.

### Example 10

A lithium-sulfur battery of Example 10 was obtained in the same process as that in Example 1, except for adding 1% by mass of sulfur-modified polyacrylonitrile (SPAN) to the positive electrode mixture layer with respect to the entire positive electrode mixture layer, and setting the mass ratio of the sulfur-carbon composite powder, the ceramic powder, AB that is the conductive additive, the binder, and the sulfur-modified polyacrylonitrile (hereinafter referred to as “sulfur-carbon composite powder:ceramics:AB:binder:SPAN”) to 80:4:10:5:1.

### Comparative Example 1

A lithium sulfur battery of Comparative Example 1 was obtained in the same process as that in Example 1, except for setting the ratio of sulfur-carbon composite powder:ceramics:AB:binder to 85:0:10:5.

### Comparative Example 2

A lithium sulfur battery of Comparative Example 2 was obtained in the same process as that in Example 1, except for setting the mixing ratio of ketjen black powder and sulfur powder to 10:90 as the mass ratio when preparing the sulfur-carbon composite powder, and setting the ratio of sulfur-carbon composite powder:ceramics:AB:binder to 90:5:2:3.

### Comparative Example 3

A lithium-sulfur battery of Comparative Example 3 was obtained in the same process as that in Example 1, except for setting the ratio of sulfur-carbon composite powder:ceramics:AB:binder to 55:30:10:5.

### Comparative Example 4

A lithium-sulfur battery of Comparative Example 4 was obtained in the same process as that in Example 1, except for using γ-Al₂O₃ as a ceramic material that is not oxidized or reduced in a potential range of 1.0V (vs. Li/Li⁺) to 3.0V (vs. Li/Li⁺), as the ceramic material to be added to the positive electrode mixture layer.

### [Evaluation of Lithium Sulfur Battery]

For the beaker-type cell lithium-sulfur batteries of Examples 1 to 8, Example 10, and Comparative Examples 1 to 4, one cycle of oxidation and reduction was performed by cyclic voltammetry under an argon atmosphere at normal pressure, the state of the electrolyte was confirmed, and it was confirmed whether or not the dissolution of lithium polysulfide in the electrolyte could be suppressed. Since lithium polysulfide dyes the electrolyte yellow when dissolved in the electrolyte, the color tone of the electrolyte was visually checked and compared with the color code based on the RBG values, and the amount of dissolution was evaluated by selecting the color considered to be the closest from #FFE44D, #FFEC80, #FFF1A6, #FFF5BF, #FFF9D9, and #FFFFFF. The color tone is darker in the order of #FFE44D>#FFEC80>#FFF1A6>#FFF5BF>#FFF9D9>#FFFFFF, and the amount of dissolving of lithium polysulfide is higher in the same order. #FFFFFF is the lightest and has the smallest amount of dissolving of lithium polysulfide. The results are shown in Tables 1, 2, 3 and 6.

In addition, for the coin-type cell lithium-sulfur batteries of Examples 1 to 10 and Comparative Examples 1 to 4, constant current charge/discharge tests were also performed under conditions of a discharge cutoff potential of 1.0V (vs. Li/Li⁺), a charge cutoff potential of 3.3V (vs. Li/Li⁺), a current rate of 0.1 C, and a temperature of 30° C. In this case, one cycle is defined as one charge and one discharge, and is also defined similarly in subsequent tests. The discharge capacities at the first cycle per 1 g of the electrode mixture layer are shown in Tables 1, 2, 3, and 6. The ratio of the discharge capacity at the fiftieth cycle per 1 g of the electrode mixture layer when the discharge capacity of the first cycle per 1 g of the electrode mixture layer is 100% is shown in Tables 1, 2, and 3. The discharge capacity and charge capacity at the first cycle per 1 g of the electrode mixture layer, and the discharge capacity and charge capacity at the tenth cycle per 1 g of the electrode mixture layer are shown in Table 4.

In addition, for the coin-type cell lithium-sulfur batteries of Example 1 and Comparative Example 5, constant current charge/discharge tests were also performed under conditions of a discharge cutoff potential of 1.0V (vs. Li/Li⁺), a charge cutoff potential of 3.3V (vs. Li/Li⁺), a current rate of 0.1 C, and a temperature of 60° C. The results of the discharge capacity at the first to twentieth cycles are shown in Table 5.

Table 1 is a table showing the discharge capacity at the first cycle, the capacity retention rate at the fiftieth cycle, and the RGB values of the electrolyte at the first cycle in a case where various ceramic materials that are oxidized and reduced in the potential range from 1.0V (vs. Li/Li⁺) to 3.0V (vs. Li/Li⁺) are added to the positive electrode and a case where the ceramic materials are not added. In Comparative Example 1, the RGB value of the electrolyte was #FFE44D, which was darker than #FFF5BF of Examples 1 to 3, it was suggested that the amount of dissolving of lithium polysulfide was large. As for the cycle characteristics, it was found that in Comparative Example 1, the capacity retention rate was 72% at the fifty cycles, which was lower than the lowest value of 77% of Examples 1 to 3. This is considered to be due to the fact that the effect of suppressing the dissolution of lithium polysulfide could not be obtained by the addition of ceramic materials.

In particular, in Example 1, which is a system to which LTO was added, the most excellent characteristics with the capacity retention rate of 81% at fifty cycles were exhibited.

Based on the above, it was suggested that by adding various ceramic materials oxidized and reduced in a potential range from 1.0V (vs. Li/Li⁺) to 3.0V (vs. Li/Li⁺), the lithium-sulfur battery suppressing the dissolving of lithium polysulfide and having a desirable discharge capacity ratio was obtained, and that it is more desirable containing LTO.

TABLE 1

| | | Electrode | | | |
|---|---|---|---|---|---|
| | | compositions | | | |
| | | (weight ratios) | | Capacity | |
| | | (sulfur-carbon | | retention | |
| | | composite | Discharge | rates at 0.1 C | |
| | Ceramic | powder:ceramic | capacities | and 50 cycles | RGB values of |
| | materials | material:AB:binder) | (mAhg⁻¹) | (%) | electrolyte |
| Comparative | Nc | 85:0:10:5 | 696 | 72 | #FFE44D |
| example 1 | additives | | | | |
| Example 1 | LTO | 80:5:10:5 | 690 | 81 | #FFF5BF |
| Example 2 | LLTO | 80:5:10:5 | 661 | 77 | #FFF5BF |
| Example 3 | LICGC | 80:5:10:5 | 607 | 78 | #FFF5BF |
| | (Registered | | | | |
| | trademark) | | | | |

Table 2 is a table showing the discharge capacity at the first cycle, the capacity retention rate at the fiftieth cycles, and the RGB values of the electrolyte at the first cycle when the composition of the positive electrode was changed. Comparative Example 2 stopped operating as a battery due to the redox shuttle effect before reaching the fiftieth cycle. This is thought to be due to the fact that since the amount of the conductive material or the conductive additive is relatively small, the electronic conductivity is decreased and the utilization rate of sulfur is lowered. Comparative Example 3 had a good capacity retention rate at fifty cycles, but the discharge capacity at the first cycle was 541 mAhg⁻¹, which was inferior to the lowest value of 635 mAhg⁻¹ in Examples 4 to 8 by approximately 100 mAhg⁻¹, and was significantly inferior. This is thought to be due to the fact that the capacity could not be secured since the amount of sulfur was relatively small.

Based on the above, it was suggested that in the system to which contain the ceramic material oxidized and reduced in a potential range from 1.0V (vs. Li/Li⁺) to 3.0V (vs. Li/Li⁺) and set the rate of the positive electrode active material in the mixture layer to 40% by mass to 80% by mass, it is obtained the lithium polysulfide adsorption effect and obtained a lithium sulfur battery having a desirable discharge capacity ratio. Furthermore, it was also suggested that excellent characteristics were exhibited when the ceramic material in an amount of 1% by mass or more and 20% by mass or less was contained.

TABLE 2

| | Rates of | Electrode | | Capacity | |
|---|---|---|---|---|---|
| | sulfur-carbon | compositions | | retention | |
| | composite | (weight ratios) | Discharge | rates at 0.1 C | |
| | powder in the | (sulfur-carbon composite | capacities | and 50 cycles | RGB values of |
| | mixture layer | powder:LTO:AB:binder) | (mAhg⁻¹) | (%) | electrolyte |
| Comparative | 81% | 90:5:2:3 | 508 | — | #FFF9D9 |
| example 2 | | | | | |
| Comparative | 38% | 55:30:10:5 | 541 | 87 | #FFEC80 |
| example 3 | | | | | |
| Example 4 | 63% | 90:5:2:3 | 705 | 72 | #FFF9D9 |
| Example 5 | 59% | 84:1:10:5 | 695 | 75 | #FFF1A6 |
| Example 6 | 58% | 83:2:10:5 | 696 | 79 | #FFF1A6 |
| Example 7 | 53% | 75:10:10:5 | 690 | 82 | #FFF9D9 |
| Example 8 | 46% | 65:20:10:5 | 635 | 85 | #FFEC80 |

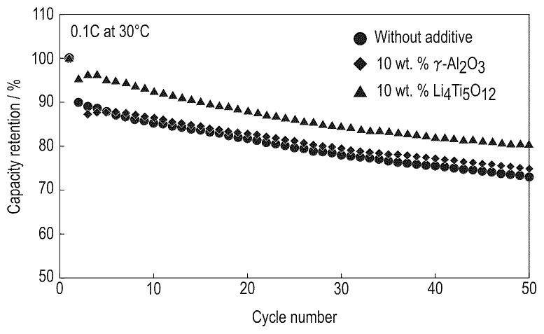

FIG. 1 is a graph showing the ratio of the discharge capacity of each cycle up to fiftieth cycles, in a case where each the initial capacity of Example 1, Comparative Example 1, and Comparative Example 4 is set to 100%. In FIG. 1, “10 wt % Li₄Ti₅O₁₂” is the result of Example 1, “Without additive” is the result of Comparative Example 1, and “10 wt % γ-Al₂O₃” is the result of Comparative Example 4.

In addition, Table 3 is a table showing the discharge capacity at the first cycle, the capacity retention rate at the fiftieth cycles, and the RGB values of the electrolyte at the first cycle in Example 1, Comparative Example 1, and Comparative Example 4.

It was shown from FIG. 1 and Table 3 that in Comparative Example 4 to which γ-Al₂O₃ had the initial capacitance of 701 mAhg⁻¹, it is not considered significantly different from 690 mAhg⁻¹ of Example 1. In addition, Comparative Example 4 had a capacity retention rate at fiftieth cycles of 74%, which is equivalent to that of Comparative Example 1 in which no ceramic material is added. Therefore, it is shown that Comparative Example 4 is inferior to Example 1 to which Li₄Ti₅O₁₂ was added. This is thought to be due to the fact that since the ceramic material oxidized and reduced in the potential range of 1.0V (vs. Li/Li⁺) to 3.0V (vs. Li/Li⁺) was not contained, the effect of promoting the reaction of sulfur or the sulfur compound could not be obtained when the ceramic material was oxidized and reduced in a potential range from 1.0V (vs. Li/Li⁺) to 3.0V (vs. Li/Li⁺), and that the strong lithium polysulfide adsorption effect of the titanium-containing oxide could not be obtained and the overvoltage could not be suppressed.

Based on the above, it was suggested that in the system to which Li₄Ti₅O₁₂ is added, the lithium-sulfur battery in which dissolution of lithium polysulfide is suppressed, overvoltage is suppressed, and a discharge capacity is increased can be obtained.

TABLE 3

| | | Electrode | | | |
|---|---|---|---|---|---|
| | | compositions | | | |
| | | (weight ratios) | | Capacity | |
| | | (sulfur-carbon | | retention | |
| | | composite | Discharge | rates at 0.1 C | |
| | Ceramic | powder:ceramic | capacities | and 50 cycles | RGB values of |
| | materials | material:AB:binder) | (mAhg⁻¹) | (%) | electrolyte |
| Comparative | No | 85:0:10:5 | 696 | 72 | #FFE44D |
| example 1 | additives | | | | |
| Comparative | γ-Al₂O₃ | 80:5:10:5 | 701 | 74 | #FFF1A6 |
| example 4 | | | | | |
| Example 1 | LTO | 80:5:10:5 | 690 | 81 | #FFF5BF |

Table 4 is a table showing the discharge capacity at the first cycle, the charge capacity at the first cycle, the discharge capacity at the tenth cycle, and the charge capacity at the tenth cycle in Example 1 and Example 9.

In Table 4, it was confirmed that the initial capacity tends to increase in Example 9 to which 1M LiTFSI DOL/DME (1.5% by mass LiNO₃) with a high lithium polysulfide solubility was applied. It was also confirmed that the redox shuttle effect occurs since the charge capacity is larger than the discharge capacity. It was also confirmed that the capacity deterioration is large at tenth cycles but the discharge capacity at the tenth cycle is equivalent to that in Example 1 and the capacity deterioration practically has no problem. In contrast, in Example 1 using LiTFSI/SL (molar ratio 1:2) with a low solubility, the initial capacity was small, but the redox shuttle behavior was not observed and the cycle maintenance rate was excellent. In addition, the same effects as those in example 1 were also obtained in the other examples.

Based on the above, it was suggested that the lithium-sulfur battery having a higher capacity retention rate by using LiTFSI/SL (molar ratio of 1:2) with a low solubility, can be obtained.

TABLE 4

| | | 1st cycle | 10th cycle |
|---|---|---|---|
| | | (Discharge capacity | (Discharge capacity |
| | | (mAhg⁻¹)/ | (mAhg⁻¹)/ |
| | | Charge capacity | Charge capacity |
| | Electrolyte | (mAhg⁻¹)) | (mAhg⁻¹)) |
| Example 9 | 1M LiTFSI DOL/DME | 873/925 | 572/913 |
| | (1.5 mass % LiNO3) | | |
| Example 1 | LiTFSI/SL | 660/656 | 567/566 |
| | (Molar ratio 1:2) | | |

Table 5 shows a table showing results of discharge capacity in each cycle, obtained by performing the constant current charge/discharge test and evaluating high temperature characteristics due to the addition of ceramic powder, under the conditions of the discharge cutoff potential of 1.0V (vs. Li/Li⁺), charge cutoff potential of 3.3V (vs. Li/Li⁺), current rate of 0.1 C, and a temperature of 60° C., for the lithium-sulfur batteries of Example 1 and Comparative Example 1.

In Comparative Example 1, which is the condition including no addition of ceramic powder, a short circuit occurred after several cycles of the test, leading to the end of the battery life. This is thought to be due to the fact that since the lithium polysulfide adsorption effect could not be obtained without containing the ceramic material, in a high-temperature environment, which is a more severe condition. In contrast, in Example 1 in which Li₄Ti₅O₁₂ was added, it was confirmed that stable charging and discharging could be performed even in a high temperature environment.

Based on the above, it was suggested that the configuration of the present disclosure is useful even in a high temperature environment.

TABLE 5

| | Electrode | | | | | |
|---|---|---|---|---|---|---|
| | compositions | | | | | |
| | (weight ratios) | | | | | |
| | (sulfur-carbon | | | | | |
| | composite | | | | | |
| | powder:ceramic | 1st cycle | 5th cycle | 10th cycle | 12th cycle | 20th cycle |
| | material:AB:binder) | (mAhg⁻¹) | (mAhg⁻¹) | (mAhg⁻¹) | (mAhg⁻¹) | (mAhg⁻¹) |
| Comparative | 85:0:10:5 | 669 | 650 | 623 | Operation | — |
| example 1 | | | | | stopped | |
| | | | | | by redox | |
| | | | | | shuttle | |
| Example 1 | 80:5:10:5 | 638 | 618 | 605 | — | 592 |

From Table 6, a capacity equivalent to Example 1, i.e., a system in which LTO was added, was confirmed in Example 10, in which a small amount of SPAN was added. In addition, when the amount of lithium polysulfide eluted into the electrolyte was evaluated. It was confirmed that Example 10 had the RGB values of the electrolyte of #FFF9D9, which is lighter than #FFF5BF in Example 1 and the dissolving amount was reduced.

Based on the above, it was suggested that dissolving of lithium polysulfide into the electrolyte can be suppressed if SPAN is used.

TABLE 6

| | Electrode | | |
|---|---|---|---|
| | compositions | | |
| | (weight ratios) | | |
| | (sulfur-carbon | | |
| | composite pow- | Discharge | |
| | der:LTO:AB:bind- | capacities | RGB values of |
| | er:SPAN) | (mAhg⁻¹) | electrolyte |
| Example 1 | 80:5:10:5:0 | 690 | #FFF5BF |
| Example 10 | 80:4:10:5:1 | 701 | #FFF9D9 |

Based on the above, according to the configuration of the present disclosure, a positive electrode and a lithium-sulfur battery that are capable of suppressing the dissolution of lithium polysulfide or the like in an electrolyte and that have a good capacity retention rate without significantly degraded initial capacity, can be provided.

Additional advantages and modifications will readily occur to those skilled in the art. Therefore, the disclosure in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A positive electrode for lithium-sulfur battery, including a positive electrode current collector and a positive electrode mixture layer, wherein
the positive electrode mixture layer contains:
sulfur and/or a sulfur compound;
a ceramic material that is oxidized and reduced in a potential range of 1.0V (vs. Li/Li⁺) to 3.0V (vs. Li/Li⁺); and
a binder, and
a proportion of the sulfur and/or the sulfur compound in the positive electrode mixture layer is 40% by mass to 80% by mass.

2. The positive electrode for lithium-sulfur battery of claim 1, wherein
a content of the ceramic material in the positive electrode mixture layer is 1% by mass or more and 20% by mass or less.

3. The positive electrode for lithium-sulfur battery of claim 1, wherein
the ceramic material is ceramic that adsorbs a lithium polysulfide, and the lithium polysulfide is generated during charging and discharging of the lithium-sulfur battery.

4. The positive electrode for lithium-sulfur battery of claim 1, wherein
the sulfur compound is at least one or more of compounds selected from Li₂Sₙ (n≥1), an organic sulfur compound, and a carbon-sulfur polymer ((C₂Sₓ)ₙ, where, x=2.5 to 50, n≥2).

5. The positive electrode for lithium-sulfur battery of claim 1, wherein
the ceramic material is at least one or more of materials selected from Li₄Ti₅O₁₂, La_{0.57}Li_{0.29}TiO₃, and Li_{1+x+y}AlₓTi₂₋ₓSi_{y}P_{3-y}O₁₂ (0≤x≤1, 0≤y≤1).

6. The positive electrode for lithium-sulfur battery of claim 1, wherein
the positive electrode mixture layer further contains sulfur-modified polyacrylonitrile.

7. A lithium-sulfur battery comprising:
the positive electrode of claim 1;
a negative electrode containing an active material containing lithium;
an electrolyte; and
a separator.

8. The lithium-sulfur battery of claim 7, wherein
a lower limit of a discharge potential range is 1.0 (vs. Li/Li⁺) to 1.5V (vs. Li/Li⁺).

9. The lithium-sulfur battery of claim 7, wherein
a solubility of a lithium polysulfide in the electrolyte is a range of 0.0 mol/L or more and 1.0 mol/L or less, and the lithium polysulfide is generated in the electrolyte during charging and discharging of the lithium-sulfer battery.

10. The lithium-sulfur battery of claim 9, wherein
the electrolyte contains lithium bis(trifluoromethanesulfonyl)imide and sulfolane are mixed at a molar ratio of 1:1 to 1:8.
